(19) United States
(12) Patent Application Publication
(10) Pub. No.: US 2016/0105534 A1
(43) Pub. Date: Apr. 14, 2016

(54) PHYSICAL SWITCH INITIALIZATION USING REPRESENTATIONAL STATE TRANSFER SERVICES

(71) Applicant: Futurewei Technologies, Inc., Plano, TX (US)

(72) Inventors: Li LI, Bridgewater, NJ (US); Wu CHOU, Basking Ridge, NJ (US)

(21) Appl. No.: 14/512,918

(22) Filed: Oct. 13, 2014

(51) Int. Cl. H04L 29/06; H04L 12/931

(52) U.S. Cl. CPC H04L 69/18; H04L 69/16; H04L 49/35

(57) ABSTRACT

Using a representational state transfer services framework (REST), embodiments of the present invention can improve interoperability between SDN controllers and network devices (e.g., physical switches, routers, etc.) of different vendors through the use of dynamically created logical switches loaded from the SDN controller. Embodiments of the present invention allow the SDN controller to serve a plurality of different network device types a logical switch directly or can redirect them to another controller/repository, e.g. for load balancing. After loading the logical switches on the network devices in the manner described by embodiments of the present invention, a network administrator can remotely invoke various services defined in the logical switches which also allow the administrator to configure network devices automatically. By increasing interoperability between network devices in this fashion, a SDN can evolve or change services dynamically in a manner that also saves memory and allows for improved network security.

### TECHNICAL FIELD

The present disclosure relates generally to the field of computer networking

### BACKGROUND OF INVENTION

In a software-defined network (SDN) architecture, the control plane that implements important network routing and switching functionalities and the data forwarding plane are decoupled. The control plane in a SDN can be logically centralized and implemented within a variety of computer hardware of varied architectures. As such, the data plane in a SDN may utilize network devices (e.g. switches and routers) that are separated from the controller hardware components. As a result of this separation, the data plane and the control plane may evolve independently and impair the communications between the two planes when their protocols are not interoperable, especially when the networks are virtualized by software.

For example, the communications between an OpenFlow switch and the SDN controller will break if the switch upgrades the OpenFlow version while the controller does not. When SDN switches added to the network expose a variety of APIs that the controller does not yet support, the switches cannot be controlled by the controller as expected. Similarly, if a SDN controller deploys a new southbound API that is not supported by a switch, the switch is out of the control of the SDN controller. As such, an architecture and protocol is needed to better facilitate interoperability between the control plane and data plane within an SDN framework.

### SUMMARY OF THE INVENTION

Therefore, it would be advantageous to provide a protocol that facilitates interoperability between SDN controllers and network devices (e.g., physical switches, routers, etc.) in a manner that allows SDN controllers to efficiently control and monitor the network while the control and data planes evolves independently.

Using a representational state transfer service (REST) framework, embodiments of the present invention can improve interoperability between SDN controllers and network devices of different vendors through the use of dynamically created logical switches loaded from the SDN controller. Embodiments of the present invention allow the SDN controller to serve a plurality of different network device types a logical switch directly or can redirect them to another controller/repository, e.g. for load balancing.

After loading the logical switches on the network devices in the manner described by embodiments of the present invention, a network administrator can remotely invoke various services defined in the logical switches which also allow the administrator to configure network devices automatically. By increasing interoperability between network devices in this fashion, a SDN controller can evolve or change services on network devices dynamically in a manner that also saves memory and allows for improved network security.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1A depicts an exemplary hardware configuration implemented on a SDN controller system for performing SDN network device (e.g. switch and router) initialization for REST services in accordance with embodiments of the present invention.

FIG. 1B depicts exemplary components resident in memory executed by a SDN controller system for performing SDN network device initialization for REST services in accordance with embodiments of the present invention.

FIG. 2A depicts an exemplary hardware configuration implemented on a network device for performing SDN network device initialization for REST services in accordance with embodiments of the present invention.

FIG. 2B depicts exemplary components resident in memory executed by a network device for performing SDN network device initialization for REST services in accordance with embodiments of the present invention.

FIG. 3A depicts an exemplary HTTP request message and response message between a SDN controller module and a SDN control agent module for performing SDN network device initialization for REST services in accordance with embodiments of the present invention.

FIG. 3B depicts exemplary components of a logical switch representation for performing SDN network device initialization for REST services in accordance with embodiments of the present invention.

FIG. 3C depicts an exemplary logical switch group for performing SDN network device initialization for REST services in accordance with embodiments of the present invention.

FIG. 4A is a flowchart of an exemplary computer-implemented method for SDN network device initialization for REST services in accordance with embodiments of the present invention.

FIG. 4B is another flowchart of an exemplary computer-implemented method for SDN network device initialization for REST services in accordance with embodiments of the present invention.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. Although a method may be depicted as a sequence of numbered steps for clarity, the numbering does not necessarily dictate the order of the steps. It should be understood that some of the steps may be skipped, performed in parallel, or performed without the requirement of maintaining a strict order of sequence. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving” or “executing” or “loading” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or display devices. When a component appears in several embodiments, the use of the same reference numeral signifies that the component is the same component as illustrated in the original embodiment.

### Exemplary SDN Controller System Configuration

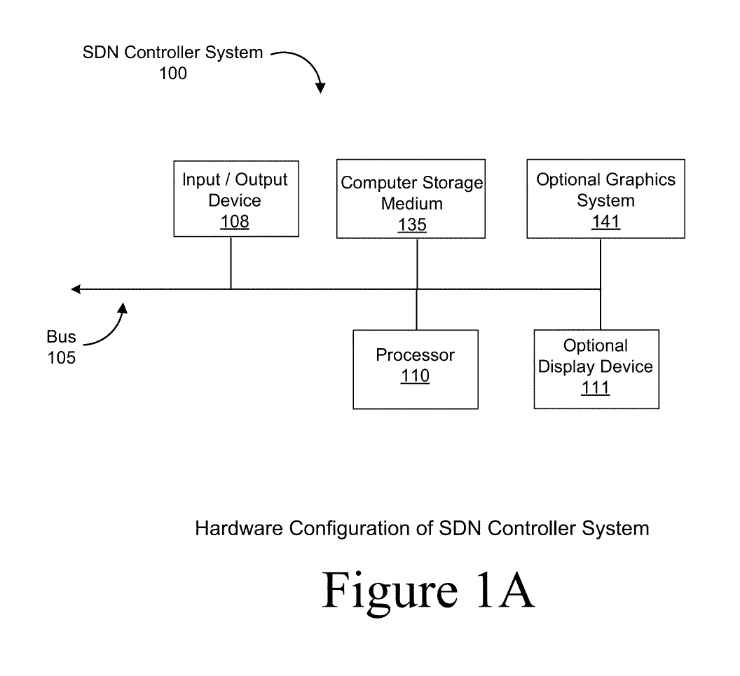

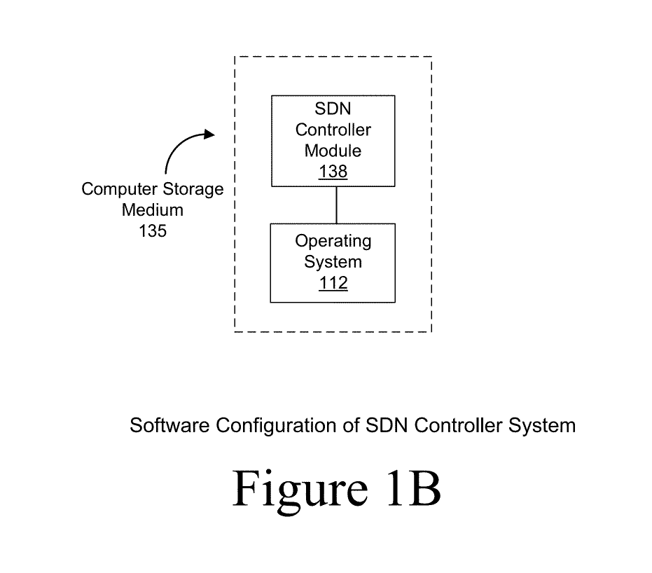

FIG. 1A illustrates an exemplary configuration of a SDN Controller System 100 capable of performing SDN network device (e.g., network switches, routers, etc.) initialization procedures for REST services in accordance with embodiments of the present invention. The term “representation” herein may correspond to document, HTML page, file, image, HTTP message entity, instance, or variant. A representation may be of any media type that is well known in the art, such as XML, text/HTML, JSON, MIME MultiPart, image, video, or a binary file. It will be appreciated that the present disclosure is not limited to any particular communication protocol in which a representation is distributed through the network.

Although specific components are disclosed in FIG. 1A, it should be appreciated that such components are exemplary. That is, embodiments of the present invention are well suited to having various other hardware components or variations of the components recited in FIG. 1A. It is appreciated that the hardware components in FIG. 1A can operate with other components than those presented, and that not all of the hardware components described in FIG. 1A are required to achieve the goals of the present invention.

SDN Controller System 100 can be implemented as an electronic device (e.g., remote controller device or other remote networking device) capable of communicating with other remote computer systems over a data communications network. The exemplary SDN Controller System 100 upon which embodiments of the present disclosure may be implemented includes a general purpose computing system environment. In its most basic configuration, SDN Controller System 100 typically includes at least one processing unit 110 and memory storage unit (e.g., computer readable storage medium 135). Depending on the exact configuration and type of device, computer readable storage medium 135 can be volatile (such as RAM), non-volatile (such as ROM, flash memory, etc.) or some combination of the two. Portions of computer readable storage medium 135, when executed, facilitate efficient execution of memory operations or requests for groups of threads.

The processor 110 can be a circuit configured to perform SDN controller functions described herein. Alternatively, the processor 110 can be operable to execute an SDN controller program stored in computer readable storage medium 135 and configured to perform functions described herein (e.g., see SDN controller module 138 of FIG. 1B discussed infra). SDN Controller System 100 may also comprise an optional graphics subsystem 141 for presenting information to the computer user, e.g., by displaying information on an optional display device 111.

According to embodiments of the present disclosure, the optional graphics subsystem 141 may be coupled directly to the optional display device 111 through a video cable. In alternative embodiments, optional display device 111 may be integrated into the computing system (e.g., a laptop or netbook display panel) and will not require a video cable. SDN Controller System 100 also comprises an optional alphanumeric input/output device 108. Input/output device 108 can include an optional cursor control or directing device, and one or more signal communication interfaces (e.g., a network interface card). Input/output device 108 can also function as a transceiver and perform transmitting and receiving procedures for SDN Controller System 100. In this fashion, input/output device 108 allows SDN Controller System 100 to communicate with other computer systems (e.g., network device 200) within a REST framework via an electronic communications network, including wired and/or wireless communication and including the Internet.

Additionally, SDN Controller System 100 may also have additional features and functionality. For example, SDN Controller System 100 may also include additional storage media (removable and/or non-removable) including, but not limited to, magnetic or optical disks or tape. Computer storage media includes volatile and nonvolatile, removable and non-removable media implemented in any method or technology for storage of information such as computer readable instructions, data structures, program modules or other data.

FIG. 1B depicts exemplary computer storage medium components used by various embodiments of the present invention. Although specific components are disclosed in FIG. 1B, it should be appreciated that such computer storage medium components are exemplary. That is, embodiments of the present invention are well suited to having various other components or variations of the computer storage medium components recited in FIG. 1B. It is appreciated that the components in FIG. 1B can operate with other components than those presented, and that not all of the computer storage medium components described in FIG. 1B are required to achieve the goals of the present invention.

As depicted in FIG. 1B, computer readable storage medium 135 includes an operating system 112. Operating system 112 loads into processor 110 when SDN Controller System 100 is initialized. Also, upon execution by processor 110, operating system 112 is configured to supply a programmatic interface to SDN Controller System 100. The communication interface also includes wireless communication mechanisms. Through such communication interfaces, SDN Controller System 100 can be communicatively coupled to other computer systems over a communication network such as the Internet or an intranet (e.g., a local area network), or can receive data (e.g., a digital television signal).

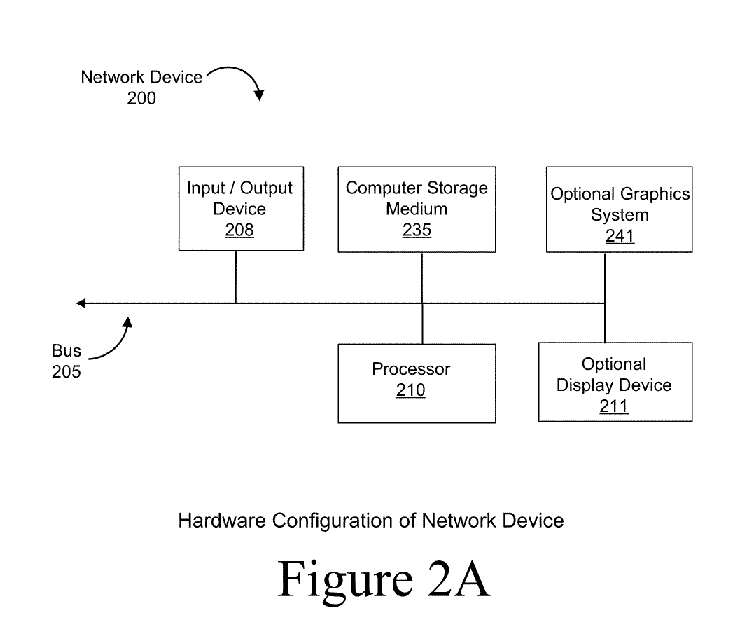

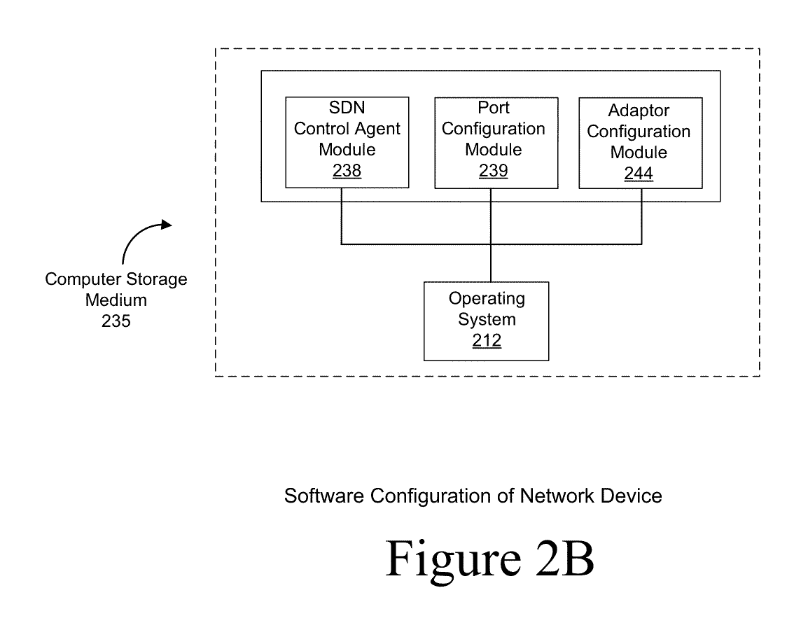

Furthermore, as illustrated in FIG. 1B, computer readable storage medium 135 includes SDN controller module 138 which provides instructions to processor 110 for processing via internal bus 105. SDN controller module 138 includes the functionality to dynamically create a plurality of different logical switches, which can then be stored on a data structure, such as a database (not pictured). Data structures storing logical switches may reside on the same computer system as SDN controller module 138 or another computer system that is accessible to SDN controller module 138. Logical switches created by SDN controller module 138 are used to configure the properties of network device ports and/or network adapters (e.g., port configuration module 239 and/or adaptor configuration module 244 of FIG. 2B). The SDN controller module 138 includes the functionality to selectively apply a set of configuration settings to a desired set of network adapters and/or ports within a given logical switch. Furthermore, SDN controller module 138 provides an abstraction of network functions with a northbound API for application programs residing on a SDN Controller System that configures a computer network dynamically.

Logical switches created by SDN controller module 138 are based on the different hardware and/or software profiles of various network devices (e.g., network device 200 of FIG. 2B) and/or their respective SDN control agent modules 238. Logical switches created by SDN controller module 138 are subsequently selected by SDN control agent modules 238 based on their respective local network device's computing environment (e.g., hardware and/or software settings such as CPU capabilities, storage capabilities, resident operating system etc.).

Once logical switches are executed and installed on network devices by a SDN control agent module 238, SDN controller module 138 then interacts with the forwarding plane and make real-time adjustments to a plurality of network devices without direct knowledge of each individual network device's particular hardware and/or software profile. In this manner, configurations expressed in logical switches enable the SDN controller module 138 to control the behaviors of underlying data forwarding elements (e.g., switches and routers) through southbound APIs using well-known communication protocols (e.g., OpenFlow, x86 instructions set, MPLS, Click software router module, functional programming model, etc.).

SDN controller module 138 communicates with the SDN control agent modules 238 of remote network devices through communication interfaces over a data communications network (e.g., SDN). For instance, using a signal communication interface, SDN controller module 138 communicates with the SDN control agent module 238 (e.g., see FIG. 2B, discussed infra) of a plurality of different remote network devices through TCP/IP connections. As such, SDN controller module 138 receives communications from the SDN control agent module 238 of different remote network devices and gather information concerning their respective local computing environment (e.g., hardware and/or software settings, including CPU capabilities, storage capabilities, resident operating system etc.).

Information gathered by SDN controller module 138 is then subsequently used to dynamically create and/or update a logical switch that can be properly executed on each individual network device. In this manner, SDN controller module 138 provides several different remote network devices access to logical switches that can be executed on their respective environments. Also, based on communications with SDN control agent modules 238, the SDN controller module 138 also identifies and/or tracks a plurality of different remote network devices and communicates their identity on the network to a third party computer system, such as a host computer system or server.

The SDN controller module 138 also sends messages to the SDN control agent module(s) 238 to load a logical switch representation created by the SDN controller module. In this fashion, newly added network devices use logical switches created by the SDN controller module 138 to facilitate installation and/or initialization procedures of communication protocols that enable SDN controller systems to communicate with network devices (e.g., routers, switches). Additionally, previously existing network devices also receive updated configurations expressed in newly created logical switches.

Furthermore, logical switches created by the SDN controller module 138 can be modeled as resource representations within a REST service architecture. As such, logical switches include different REST services (e.g., start, stop, update, delete, etc.) that are offered by the resource. A service is identified by a URI for a service client to access the service. After accessing the logical switch URI, a service client then obtains hyperlinks in the representation to access the services. Furthermore, the SDN control agent module 238 of different remote network devices can share the same logical switch URI created by the SDN controller module 138 or each can have a different logical switch URI based on their respective local computing environment.

### Exemplary SDN Network Device Configuration

FIG. 2A illustrates an exemplary configuration of a network device 200 capable of performing SDN network device initialization procedures for REST services in accordance with embodiments of the present invention. Although components of network device 200 described in FIGS. 2A and 2B include similar components described with respect to SDN Controller System 100, network device 200 can include fewer or more components. Although specific components are disclosed in FIG. 2A, it should be appreciated that such components are exemplary. That is, embodiments of the present invention are well suited to having various other hardware components or variations of the components recited in FIG. 2A. It is appreciated that the hardware components in FIG. 2A can operate with other components than those presented, and that not all of the hardware components described in FIG. 2A are required to achieve the goals of the present invention.

Network device 200 can be implemented as an electronic device capable of communicating with other remote computer systems (e.g., SDN Controller System 100) over a data communications network (e.g., SDN). The exemplary network device 200 upon which embodiments of the present disclosure may be implemented includes a general purpose computing system environment. In its most basic configuration, network device 200 typically includes at least one processing unit 210 and memory storage unit (e.g., computer readable storage medium 235).

Depending on the exact configuration and/or type of network device, computer readable storage medium 235 can be volatile (such as RAM), non-volatile (such as ROM, flash memory, etc.) or some combination of the two. Portions of computer readable storage medium 235, when executed, facilitate efficient execution of memory operations or requests for groups of threads. The processor 210 may be a circuit configured to perform control agent module functions described herein. Alternatively, the processor 210 may be operable to execute an SDN controller program stored in computer readable storage medium 235 of the network device 200 and configured to perform functions described herein.

Network device 200 also comprises an optional graphics subsystem 241 for presenting information to the computer user, e.g., by displaying information on an optional display device 211. According to embodiments of the present disclosure, the optional graphics subsystem 241 may be coupled directly to the optional display device 211 through a video cable. In alternative embodiments, optional display device 211 may be integrated into the computing system (e.g., a laptop or netbook display panel) and will not require a video cable. Network device 200 also comprises an optional alphanumeric input/output device 208. Input/output device 208 can include an optional cursor control or directing device, and one or more signal communication interfaces (e.g., a network interface card, adaptor configuration module 244 of FIG. 2B). Input/output device 208 can function as a transceiver and perform transmitting and receiving procedures for network device 200. In this fashion, input/output device 208 allows network device 200 to communicate with other computer systems (e.g., SDN Controller System 100) within a REST framework via an electronic communications network, including wired and/or wireless communication and including the Internet.

Additionally, network device 200 may also have additional features and functionality. For example, network device 200 may also include additional storage media (removable and/or non-removable) including, but not limited to, magnetic or optical disks or tape. Computer storage media includes volatile and nonvolatile, removable and non-removable media implemented in any method or technology for storage of information such as computer readable instructions, data structures, program modules or other data.

FIG. 2B depicts exemplary computer storage medium components used by various embodiments of the present invention. Although specific components are disclosed in FIG. 2B, it should be appreciated that such computer storage medium components are exemplary. That is, embodiments of the present invention are well suited to having various other components or variations of the computer storage medium components recited in FIG. 2B. It is appreciated that the components in FIG. 2B can operate with other components than those presented, and that not all of the computer storage medium components described in FIG. 2B are required to achieve the goals of the present invention.

As depicted in FIG. 2B, computer readable storage medium 235 includes an operating system 212. Operating system 212 is loaded into processor 210 when network device 200 is initialized. Also, upon execution by processor 210, operating system 212 is configured to supply a programmatic interface to network device 200. For instance, operating system 212 supplies a signal communication interface through port configuration module 239 and/or adaptor configuration module 244. The communication interface also includes wireless communication mechanisms. Through such communication interfaces, network device 200 communicatively couples to other computer systems over a data communications network such as the Internet or an intranet (e.g., a local area network), or can receive data (e.g., a digital television signal).

Furthermore, as illustrated in FIG. 2B, computer readable storage medium 235 includes SDN control agent module 238 which provides instructions to processor 210 for processing via internal bus 205. For instance, using a communication interface, SDN control agent module 238 initializes a TCP/IP connection to the SDN controller module 138 or another computer system to access a logical switch representation created by and/or loaded on the SDN controller module 138. As described herein, each logical switch identified in the logical switch representation can be executed using a different hardware and/or software profile. Accordingly, upon establishing a connection with SDN controller module 138, SDN control agent module 238 accesses and/or parses 1 or more logical switches contained in the representation.

Based on hardware and/or software profiles specified in the logical switch representation, SDN control agent module 238 determines which logical switch or switches in the logical switch representation can be installed on the SDN control agent module 238′s local network device. Determinations made by the SDN control agent module 238 can be based on the current hardware and/or software settings, such as CPU capabilities, storage capabilities, resident operating system etc., of the local network device.

If the SDN control agent module 238 determines that no logical switch within the parsed logical switch representation can be installed locally based on the current hardware and/or software settings, SDN control agent module 238 communicates real-time error messages to the SDN controller module 138 and/or or a computer system with network administration capabilities. The communications can specify the manner in which the network device is deficient to install the logical switch (e.g., hardware and/or software deficiencies). Accordingly, based on the communicated deficiencies, SDN controller module 138 dynamically creates additional and/or update existing logical switches that can lead to successful implementation of the logical switch on a previously deficient network device 200.

Alternatively, if the SDN control agent module 238 determines that a logical switch within the parsed logical switch representation can be installed locally based on the current hardware and/or software settings, SDN control agent module 238 determines whether the local computer system has the proper software packages or modules needed to execute a set of instructions or scripts associated with the logical switch. For instance, SDN control agent module 238 can determine whether the local computer system currently has the proper set of software modules or libraries needed to immediately execute the scripts specified or if it needs to instruct the local computer system to download the proper software packages and/or scripts specified in the logical switch representation from a host computer system or another computer system.

Accordingly, once the scripts are executed on the network device 200, a client computer system with network administration capabilities remotely invokes services defined in the scripts to perform various network administration tasks. Tasks may include updating and/or uninstalling the logical switch on the network device 200. Furthermore, as discussed supra, once logical switches are executed and installed, the SDN controller module 138 controls the forwarding plane behavior of network device 200 through southbound APIs using well-known communication protocols (e.g., OpenFlow, x86 instructions set, MPLS, Click software router module, functional programming model, etc.). In one embodiment, an HTTP client script can be used to configure network devices automatically.

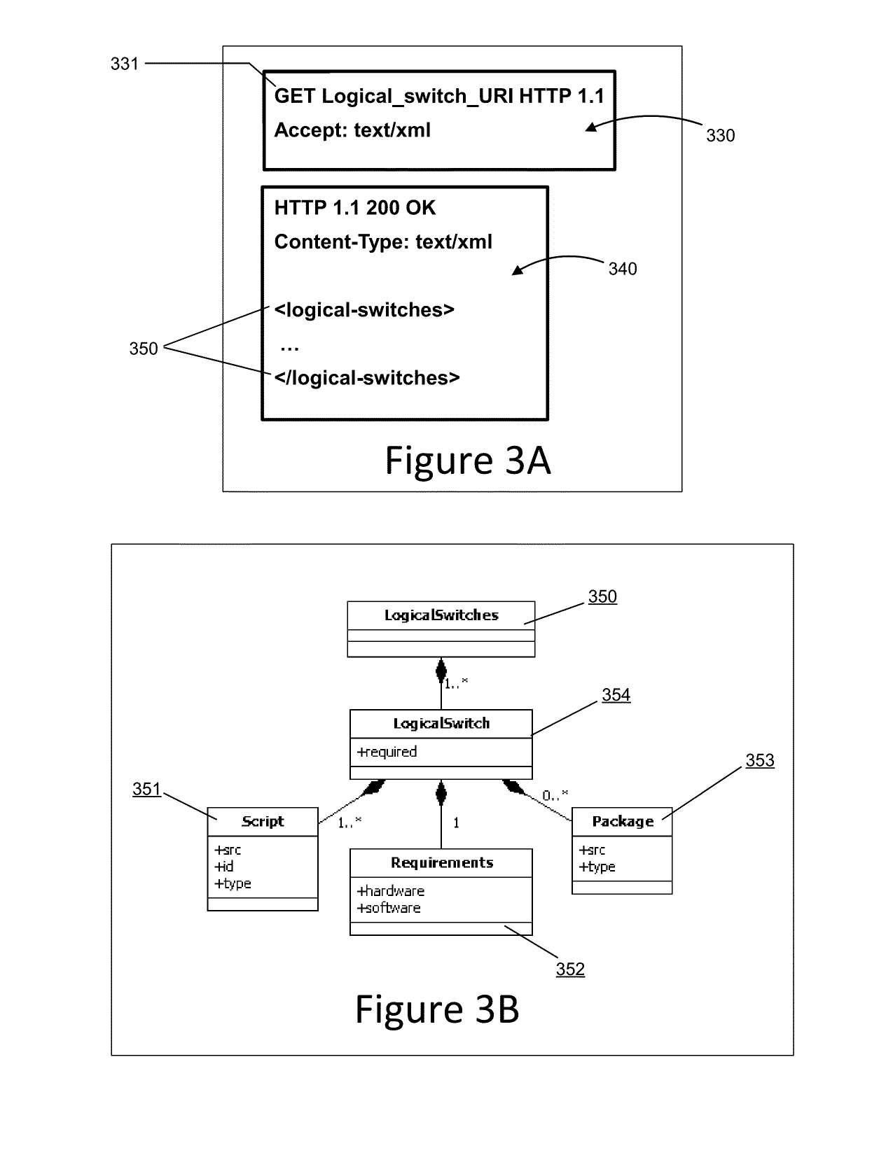

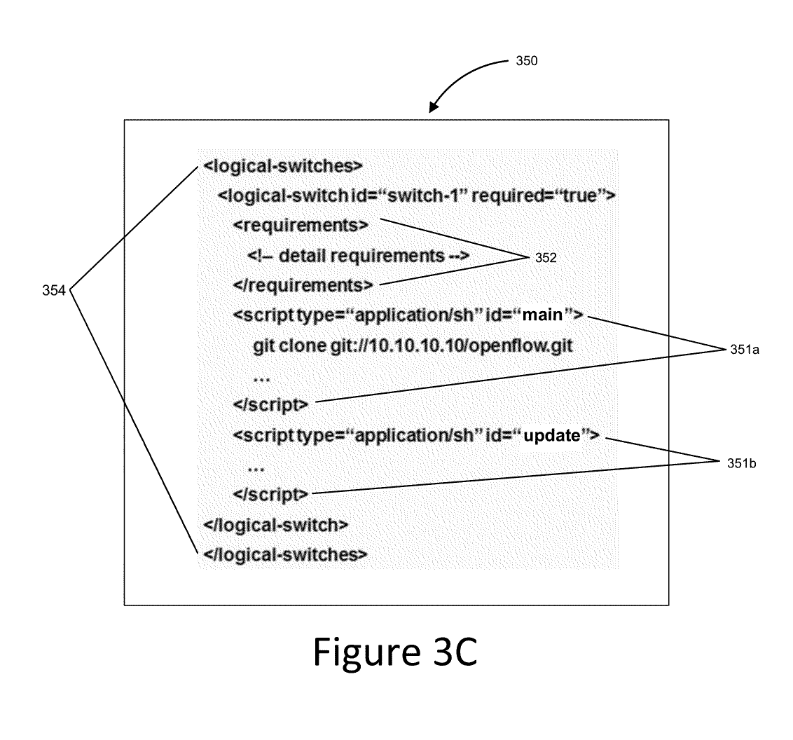

FIG. 3A depicts an exemplary HTTP request message 330 and response message 340 between a SDN controller module and a SDN control agent module using a REST architecture in accordance with embodiments of the present invention. Request message 330 includes a “Get” request 331 for retrieving a logical switch representation from the SDN controller module 138 using a particular URI (e.g., logical_switch_URI). Message 330 can be in the form of a REST resource request. In response to message 330, SDN controller module 138 returns a response message 340 that can include a representation that contains a group of defined logical switches. The protocol of communications between the SDN controller module 138 and SDN control agent module 238 of a network device can be standardized in a manner that enables SDN control agent modules 238 of different vendors (e.g., HTTP 1.1, HTTP 2.0, CORE, etc.) to communicate with the SDN controller module 138. In this manner, the SDN controller module 138 and SDN control agent module 238 can select a best logical switch representation (e.g. JSON, XML etc.) through various content negotiation mechanisms.

FIG. 3B depicts exemplary components of a logical switch representation in accordance with embodiments of the present invention. For example, logical switch group 350 can include a plurality of logical switches (e.g., logical switch 354) coded within a logical switch representation. As such, SDN control agent module 238 can load a logical switch 354 from SDN controller module 138 by parsing logical switch group 350 and locating various elements or components such as requirements element 352, script element 351, and/or packages element 353. In this fashion, the SDN control agent module 238 can instruct a program (e.g., rpm, atp, yum, git, etc.) and/or operating system (e.g., Linux, Windows) resident on the local computer system to execute a set of instructions (e.g., a main script) specified in the logical switch representation.

Requirements element 352 can specify, for example, a particular hardware and/or software profile needed by a network device (e.g., CPU capabilities, storage capabilities, resident operating system etc.) in order to successfully execute logical switch 354 locally. Script element 351 can specify, for example, a set of instructions designed to automate procedures to be performed by logical switch 354 on the local computer system. Packages element 353 can specify, for example, specific software modules or libraries that may provide the functionality needed by the local computer system to support the execution of script element 351 and/or other procedures.

FIG. 3C depicts an exemplary logical switch group in accordance with embodiments of the present invention. As described herein, logical switch group 350 can include a 1 or more logical switches (e.g., logical switch 354). Additionally, as described herein, logical switch 354 may include a number of components such as requirements element 352, script element 351a and/or 351b, and/or packages element 353. Although the logical switch coding is depicted in FIG. 3C in XML format, other formats may be used.

Requirements element 352 can specify a particular hardware and/or software profile needed by a network device to execute portions of logical switch 354. For example, requirements element 352 can include a particular hardware and/or software profile needed by a network device to execute script element 351a and/or script element 351b. Hardware and/or software profiles needed to execute script elements 351a and 351b may be the same or may be different. For instance, in one embodiment, script element 351a may require a hardware and/or software profile designed for a Linux operating system, whereas script element 351b may require a hardware and/or software profile designed for a Windows operating system. Additionally, requirements element 352 can also include instructions detailing various port and/or network adaptor configuration details.

Also, script elements 351a and/or 351b may be designed to perform various operations including installation, verification, compilation, testing, launch, delete, and update operations. As depicted in FIG. 3C, script element 351a may represent a “main” set of instructions designed to automate the installation process of a communications protocol (e.g., OpenFlow, x86 instructions set, MPLS, Click software router module, functional programming model, etc.) on the network device 200. For instance, in the example depicted in FIG. 3C, the SDN control agent module 238 of a network device can be configured to locate and execute script element 351a to initiate installation procedures of an OpenFlow communications protocol on the network device.

Alternatively, script element 351a may include instructions that facilitate the installation of another communications protocol on network device 200, such as x86 instructions set, MPLS, Click software router module, functional programming model, etc. In this fashion, communications between network device 200 and SDN controller module 138 can support alternative abstractions that allow for packet processing models that are not fixed with limited instructions and actions, i.e., fixed IPv4/IPv6 fields, fixed table and entry formats, etc.

Also, as depicted in FIG. 3C, script element 351b may be designed to perform a task or operation that is separate from script element 351a. For instance, script element 351b may be designed to perform update operations on a network device 200. As such, script element 351b may include operations that update current hardware and/or software settings on network device 200. Furthermore, packages element 353 (not shown) can include various software libraries or modules that may provide the functionality needed to support the execution of script elements 351a and/or 351b and/or other procedures to be performed by network device 200. In one embodiment, script elements 351a and 351b may be configured to work in parallel or depend on the execution of one another.

Accordingly, embodiments of the present invention can be customized to support a wider array of SDN controller vendors. By loading logical switch 354 from SDN controller module 138 in the manner described herein, instead of preloading logical switch 354 directly to network device 200, embodiments of the present invention increase interoperability between logical switches and SDN controllers while allowing each network device (e.g., routers, physical switches, etc.) to evolve or change its services dynamically. In this fashion, additional TCP/IP connections are not needed between SDN controller module 138 and network device 200.

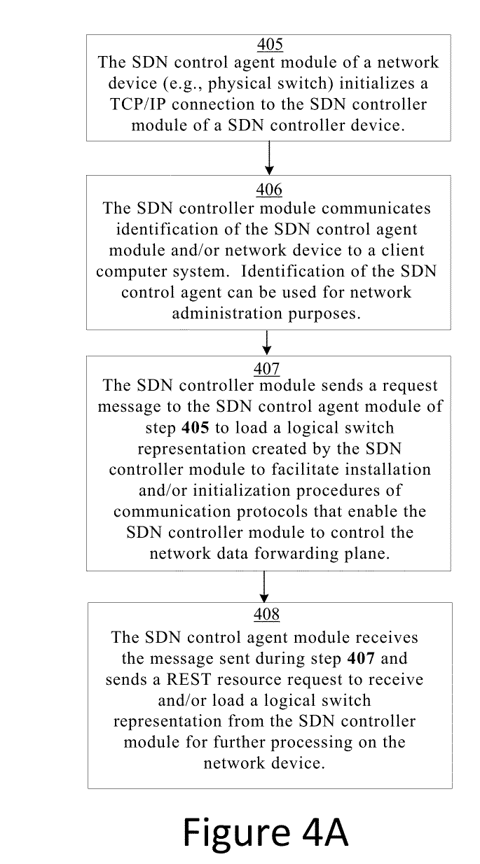

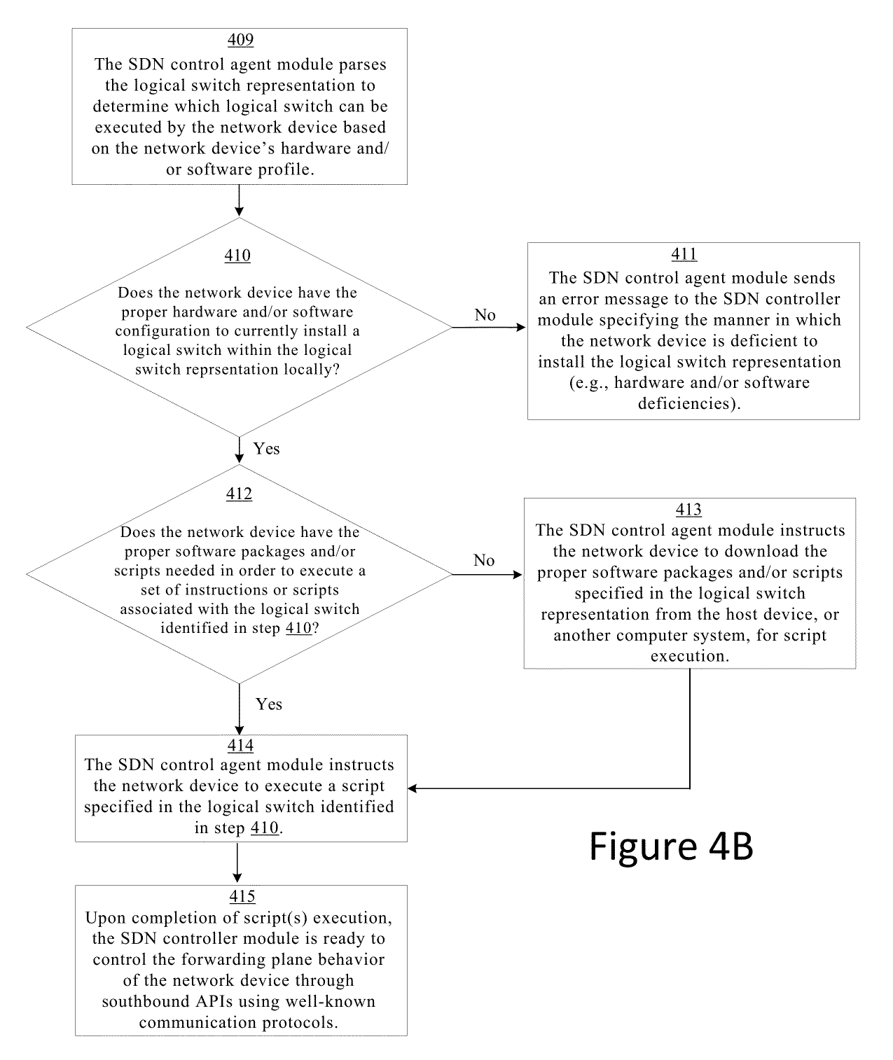

FIG. 4A is a flowchart of an exemplary computer-implemented method for SDN switch and/or router initialization for REST services in accordance with embodiments of the present invention.

At step 405, the SDN control agent module of a network device (e.g., physical switch) initializes a TCP/IP connection to the SDN controller module of a SDN controller device. The SDN controller device may be a host computer system device or another remote network computer system communicatively coupled to the SDN control agent module. Network devices can be members of the same physical data network layer as the SDN controller module or can be members of a different physical data network layer. In one embodiment, there may be a configuration manager that initiates the download. The manager can be implemented by the controller, the network device, or another computer.

At step 406, the SDN controller module communicates identification of the SDN control agent module and/or network device to a client computer system. Identification of the SDN control agent can be used for network administration purposes. For instance, using a list of SDN control agent modules identified by the SDN controller module, a network administration system can create and/or update a plurality of logical switches.

At step 407, the SDN controller module sends a message to the SDN control agent module of step 405 to load a logical switch representation created by the SDN controller module to facilitate installation and/or initialization procedures of communication protocols that enable the SDN controller module to control the network data forwarding plane. The message includes URI information that allows the network device to identify and/or load a logical switch or switches from the SDN controller module.

At step 408, the SDN control agent module receives the message sent during step 407 and sends a REST resource request to receive and/or load a logical switch representation from the SDN controller module for further processing on the network device. The logical switch representation can include one or more logical switches that can be identified and/or executed by a SDN control agent module.

FIG. 4B is another flowchart of an exemplary computer-implemented method for SDN network device initialization for REST services in accordance with embodiments of the present invention. The details of operation 408 (see FIG. 4A) are outlined in FIG. 4B.

At step 409, the SDN control agent module parses the logical switch representation to determine which logical switch can be executed by the network device based on the network device's hardware and/or software profile. Each logical switch may include a number of components capable of being parsed by the SDN control agent module (e.g., requirements element, script element, packages element, etc.). As such, each logical switch identified in the logical switch representation can be executed by network devices of a different hardware and/or software profile.

At step 410, based on the data parsed at step 409, a determination is made by the SDN control agent module as to whether the network device has the proper hardware and/or software configuration to currently install a logical switch within the logical switch representation locally. Determinations made by the SDN control agent module can be based on current hardware and/or software settings (e.g., CPU capabilities, storage capabilities, resident operating system etc.). If the SDN control agent module determines that no logical switch within the logical switch representation can be installed on the network device, then the SDN control agent module will send an error message to the SDN controller module specifying the manner in which the network device is deficient to install the logical switch (e.g., hardware and/or software deficiencies), as detailed in step 411. If the SDN control agent module determines that a logical switch within the logical switch representation can be installed on the network device, then a determination is made by the SDN control agent module as to whether the network device has the proper software packages or modules needed to execute a set of instructions or scripts associated with the logical switch identified in step 410, as detailed in step 412.

At step 411, the SDN control agent module determines that the network device does not currently have the proper hardware and/or software settings to install a logical switch locally and, therefore, the SDN control agent module sends an error message to the SDN controller module specifying the manner in which the network device is deficient to install the logical switch representation (e.g., hardware and/or software deficiencies).

At step 412, the SDN control agent module determines that the network device currently has the proper hardware and/or software settings to install a logical switch locally and, therefore, a determination is made by the SDN control agent module as to whether the network device has the proper software packages or modules needed to execute a set of instructions or scripts associated with the logical switch identified in step 410. If the SDN control agent module determines that the network device does not currently have the proper software packages and/or scripts, then the SDN control agent module instructs the network device to download the proper software packages and/or scripts specified in the logical switch representation from a host device, or another computer system, for script execution, as detailed in step 413. If the SDN control agent module determines that the network device currently has the proper software packages and/or scripts, then the SDN control agent module instructs the network device to execute a script specified by the logical switch identified in step 410, as detailed in step 414.

At step 413, the SDN control agent module determines that the network device does not currently have the proper software packages and/or scripts and, therefore, the SDN control agent module instructs the network device to download the proper software packages and/or scripts specified in the logical switch representation from the host device, or another computer system, for script execution. Once the SDN control agent module receives the proper software packages and/or scripts, then the SDN control agent module instructs the network device to execute a script specified by a logical switch identified in step 410, as detailed in step 414.

At step 414, the SDN control agent module determines that the network device currently has the proper software packages and/or scripts and, therefore, the SDN control agent module instructs the network device to execute a script specified in the logical switch identified in step 410. The script may include instructions to install, update, remove, etc., well-known communication protocols. Instructions can also include instructions detailing various port and/or network adaptor configuration details.

At step 415, upon completion of script(s) execution, the SDN controller module is ready to control the forwarding plane behavior of the network device through southbound APIs using well-known communication protocols. A computer system with network administration capabilities can remotely invoke services defined in the scripts to perform various network administration tasks involving network device.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. An apparatus comprising:
a communication interface for communicating with a remote network controller over a network; and
a processor coupled to said communication interface and configured to:
generate a representational state transfer services resource request for a logical switch from said remote network controller to install a communications protocol on said apparatus for receiving instructions to control operation of a data forwarding plane behavior corresponding to said apparatus;
select said communications protocol from a plurality of different communications protocols specified in said logical switch based on a computing environment of said apparatus; and
execute instructions specified in said logical switch to install said communications protocol locally on said apparatus.

2. The apparatus of claim 1, wherein said communication interface is operable to initialize a TCP/IP connection with said remote network controller to send said representational state transfer services resource request.

3. The apparatus of claim 1, wherein said logical switch comprises an Extensible Markup Language (XML) media type, wherein said logical switch comprises an XML element for defining a script to execute said instructions.

4. The apparatus of claim 1, wherein said communications protocol is OpenFlow.

5. The apparatus of claim 1, wherein said instructions specify a pre-determined communications channel for engaging communications between said apparatus and said remote network controller using said communications protocol.

6. The apparatus of claim 1, wherein said apparatus is a software-defined network physical switch.

7. The apparatus of claim 1, wherein said apparatus is a software-defined network router.

8. A non-transitory computer-readable storage medium having computer-executable instructions that, when executed, cause a network device to perform a method, said method comprising:
sending a representational state transfer services resource request over a network to a remote network controller to receive a logical switch for installation of a communications protocol on said network device, wherein said communications protocol enables said remote network controller to control operation a data forwarding plane corresponding to said network device;
selecting said communications protocol from a plurality of different communications protocols specified in said logical switch based on a computing environment of said network device; and
executing instructions specified in said logical switch to install said communications protocol locally on said network device.

9. The method of claim 8, wherein said sending further comprises initializing a TCP/IP connection with said remote network controller to send said representational state transfer services resource request.

10. The method of claim 8, wherein said selecting further comprises identifying a current hardware and software setting of said network device and selecting said communications protocol based on said current hardware and software setting.

11. The method of claim 8, wherein said executing further comprises downloading a script specified in said logical switch to install said communications protocol on said network device.

12. The method of claim 8, further comprising communicating with said remote network controller through said communications protocol upon installation of said communications protocol on said network device and receiving instructions from said remote network controller to adjust said data forwarding plane behavior of said network device.

13. The method of claim 8, wherein said communications protocol is OpenFlow.

14. The method of claim 8, wherein said communications protocol is x86 instruction set.

15. An apparatus comprising:
a communication interface for communicating with a remote network device over network; and.
a processor coupled to said communication interface and configured to:
receive a representational state transfer services resource request from a remote network device over a data communications network for a logical switch to install a communications protocol on said remote network device, wherein said communications protocol enables said apparatus to control a data forwarding plane behavior of said remote network device; and
upon receipt of said representational state transfer services resource request, communicate said logical switch to said remote network device over said data communications network.

16. The apparatus of claim 15, wherein said processor is configured to generate said logical switch by creating a plurality of different configurations for a plurality of different communications protocols, wherein said generated logical switch comprises instructions for said remote network device to install one of said plurality of communications protocols on said remote network device based on a computing environment of said remote network device.

17. The apparatus of claim 15, wherein said logical switch comprises an Extensible Markup Language (XML) media type, wherein said logical switch comprises an XML element for defining a script to execute said instructions.

18. The apparatus of claim 15, wherein said logical switch comprises instructions specifying a pre-determined communications channel for engaging communications between said apparatus and said remote network device using said communicationsprotocol.

19. The apparatus of claim 15, wherein said apparatus is a software-defined network controller device.

20. The apparatus of claim 15, wherein said remote network device is a software-defined network physical switch.

21. The apparatus of clain 15, wherein said network is a software-defined network.
